(19) United States
(12) Patent Application Publication
(10) Pub. No.: US 2023/0274302 A1
(43) Pub. Date: Aug. 31, 2023

(54) MANAGEMENT SERVER AND CONTROL METHOD OF THE SAME

(71) Applicant: HONDA MOTOR CO., LTD., Tokyo (JP)

(72) Inventor: Hidekazu Morishita, Wako-shi (JP)

(21) Appl. No.: 18/159,278

(22) Filed: Jan. 25, 2023

(30) Foreign Application Priority Data
Feb. 28, 2022 (JP) 2022-029329

(51) Int. Cl. G06Q 30/0208; G06Q 30/0207; G06Q 50/30

(52) U.S. Cl. CPC G06Q 30/0208; G06Q 30/0236; G06Q 50/30

(57) ABSTRACT

Provided is a management server managing rental of a battery between a lessor renting out the battery and a lessee renting the battery, the management server including a first incentive giving unit configured to give an incentive to the lessor who has rented out the battery. The first incentive giving unit gives, to the lessor, the incentive corresponding to a separation distance between a position of the battery at a point when the lessee makes a request to rent the battery and a position of a fixed station where the battery is provided.

### INCORPORATION BY REFERENCE

The present application claims priority under 35 U.S.C. § 119 to Japanese Patent Application No. 2022-029329 filed on Feb. 28, 2022. The content of the application is incorporated herein by reference in its entirety.

### BACKGROUND OF THE INVENTION

### Field of the Invention

The present invention relates to a management server and a control method of the management server.

### Description of the Related Art

Conventionally, there is known a station where batteries that can be used by users are housed (for example, see Japanese Patent Laid-Open No. 2021-103549).

In a conventional technique, there may be considered a system with which a user who owns a battery (hereinafter, referred to as “lessor”) rents out the battery to a third party user (hereinafter, referred to as “lessee”). With this system, when in need of a battery, the lessee can rent a battery from the lessor, thereby making it possible to improve the convenience for the lessee.

However, the farther the rental place of the battery is from the station as disclosed in Japanese Patent Laid-Open No. 2021-103549, the more difficult it is for the lessor to acquire a new battery from the station after renting out the battery. Therefore, with the system described above, there is concern that the lessor's willingness to rent out the battery will be reduced and rental at a location far from the station may become difficult unless an incentive is given to the lessor by taking the location of the rental place and the station into consideration, so that the lessee may not be able to rent the battery easily.

The present invention is designed in view of the aforementioned circumstances, and it is an object thereof to provide a management server capable of giving an appropriate incentive to a lessor, and a control method of the management server.

### SUMMARY OF THE INVENTION

One aspect of the present invention is a management server managing rental of a battery between a lessor renting out the battery and a lessee renting the battery, the management server including a first incentive giving unit configured to give an incentive to the lessor who has rented out the battery, in which the first incentive giving unit gives, to the lessor, the incentive corresponding to a separation distance between a position of the battery at a point when the lessee makes a request to rent the battery and a position of a fixed station where the battery is provided.

According to one aspect of the present invention, it is possible to give an appropriate incentive to the lessor.

### BRIEF DESCRIPTION OF THE DRAWINGS

FIG. 1 is a diagram illustrating a configuration of a rental system;

FIG. 2 is a diagram illustrating a configuration of a vehicle;

FIG. 3 is a diagram illustrating a configuration of a lessee terminal;

FIG. 4 is a diagram illustrating a configuration of a lessor terminal;

FIG. 5 is a diagram illustrating a configuration of a management server;

FIG. 6 illustrates flowcharts indicating operations of the rental system;

FIG. 7 illustrates flowcharts indicating operations of the rental system;

FIG. 8 is a diagram illustrating an example of a rental request screen;

FIG. 9 is a diagram illustrating an example of fees indicated by first icons;

FIG. 10 illustrates flowcharts indicating operations of the rental system;

FIG. 11 illustrates a flowchart indicating an operation of the management server;

FIG. 12 is a flowchart illustrating an operation of the management server; and

FIG. 13 illustrates flowcharts indicating operations of the management server.

### DETAILED DESCRIPTION OF THE PREFERRED EMBODIMENTS

### 1. First Embodiment

### 1-1. Configuration of Rental System

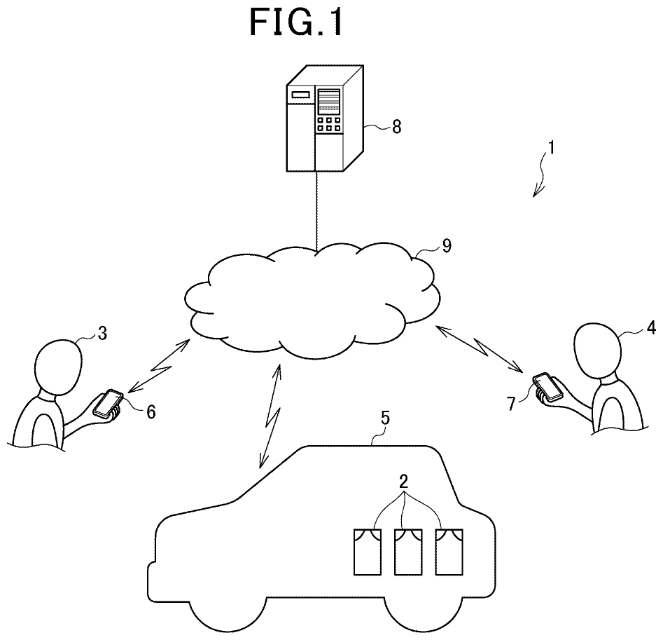

FIG. 1 is a diagram illustrating a configuration of a rental system 1 according to an embodiment.

The rental system 1 is a system that provides a rental service of a power pack 2 between a lessor 3 that rents out the power pack 2 as a portable battery and a lessee 4 that rents the power pack 2.

The power pack 2 corresponds to a battery of the present disclosure.

As illustrated in FIG. 1, the rental system 1 according to the embodiment includes: a vehicle 5 driven by the lessor 3; a lessor terminal 6 operated by the lessor 3; a lessee terminal 7 operated by the lessee 4; and a management server 8 that manages rental of the power pack 2. Each of the vehicle 5, the lessor terminal 6, the lessee terminal 7, and the management server 8 is connected to a communication network 9 such as the Internet in a mutually communicable manner.

The power pack 2 can be disposed at a prescribed position (under a seat or the like) of the vehicle 5. Furthermore, the power pack 2 is detachable to/from a charging station 53 provided to the vehicle 5. The power pack 2 includes a wireless communication device conforming to the near field communication standards such as Bluetooth (R), and transmits charge amount information indicating the charge amount of the power pack 2 and a battery ID (Identification) that uniquely identifies the power pack 2 to an external device. Note that the type (material of the electrode) of the battery of the power pack 2 is arbitrary.

The lessor 3 means the person who has the right to rent out the power pack 2 to a third party, and it is an owner of the power pack 2 or a person who has the right to sublet the power pack 2 rented from the provider or the like of the rental system 1, for example. The lessor 3 of the embodiment also has the ownership or the use right of the vehicle 5. The vehicle 5 of the embodiment is an electric four-wheeled vehicle.

The lessee 4 means a person who has the right to rent and use the power pack 2 from the lessor 3.

The management server 8 is a server computer that provides the rental service described above, which manages rental of the power pack 2 between the lessor 3 and the lessee 4.

Both of the lessor terminal 6 and the lessee terminal 7 are devices corresponding to client computers that receive the rental service provided from the management server 8.

That is, the lessor terminal 6 is a terminal device that performs processing related to renting out of the power pack 2 for the management server 8 according to an operation of the lessor 3. The lessee terminal 7 is a terminal device that performs processing related to renting of the power pack 2 for the management server 8 according to an operation of the lessee 4. The lessor terminal 6 and the lessee terminal 7 are mobile terminal devices such as smartphones or notebook personal computers, for example.

Note here that the rental service of the rental system 1 according to the embodiment is performed on conditions of the following first to eighth items.

The first item is that when the lessee 4 rents the power pack 2, the power pack 2 the lessee 4 is to rent is exchangeable with the power pack 2 the lessee 4 is using (the so-called exchange system).

The second item is that the lessee 4 can rent the power pack 2 even if the lessee 4 does not exchange the power pack 2 the lessee 4 is using with the power pack 2 to be rented.

The third item is that the lessee 4 can rent the power pack 2 even if the lessee 4 is not using the power pack 2.

The fourth item is that when the power pack 2 is exchanged by the lessee 4, the lessor 3 can rent out the power pack 2 acquired by the exchange. That is, the lessor 3 has the right to sublet the power pack 2 acquired by exchange.

The fifth item is that the power pack 2 rented out by the lessor 3 is the power pack 2 rented by the lessor 3 from the provider or the like of the rental system 1 or purchased by the lessor 3.

The sixth item is that the lessee 4 pays money to the provider of the rental system 1, the lessor 3, or the like, when renting the power pack 2.

The seventh item is that the lessor 3 receives an incentive from the provider or the like of the rental system 1 according to the rent-out performance of the power pack 2.

The eighth item is that the lessee 4 receives an incentive from the provider or the like of the rental system 1 according to the returning performance of the power pack 2 to a station ST. The station ST of the embodiment is a fixed place where the power pack 2 can be rented out and returned. The station ST may be a place where the power pack 2 can be charged.

With such a rental system 1, the lessor 3 can rent out the power pack 2 not only at their own home but also at outside places (for example, shopping malls or the like) travelled to by the vehicle 5.

Meanwhile, when the remaining battery charge of the power pack 2 in use becomes low, when the use of the power pack 2 is desired, or the like, the lessee 4 can rent the power pack 2 from the lessor 3 who is renting one out nearby.

Configurations of each of units of the rental system 1 will be described.

### 1-2. Configuration of Vehicle

First, the configuration of the vehicle 5 will be described.

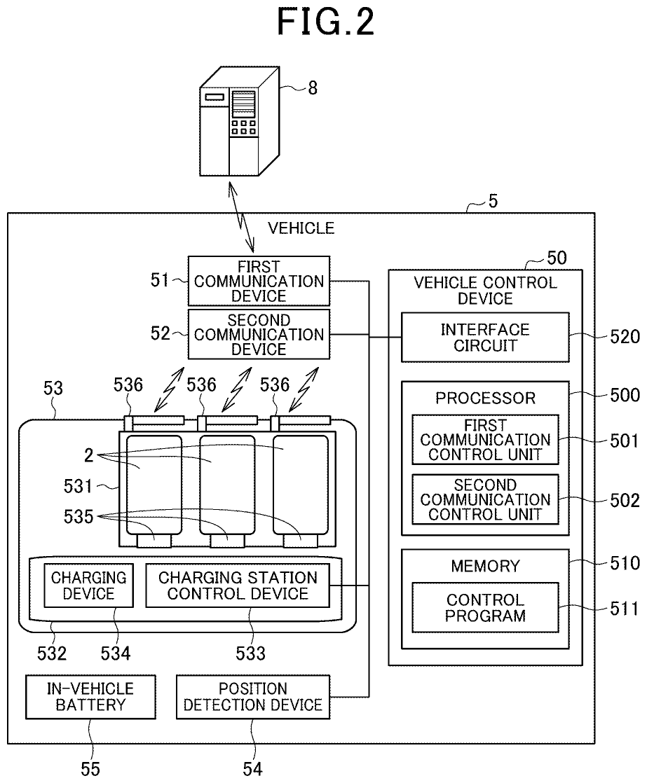

FIG. 2 is a diagram illustrating the configuration of the vehicle 5.

The vehicle 5 includes a vehicle control device 50, a first communication device 51, a second communication device 52, the charging station 53, and a position detection device 54.

The vehicle control device 50 is a device that controls each unit of the vehicle 5. The vehicle control device 50 includes a processor 500 such as a CPU (Central Processing Unit) or an MPU (Micro-Processing Unit), a memory 510, and an interface circuit 520 to which other devices and sensors are connected.

The memory 510 is a storage device that stores a program and data to be executed by the processor 500 in a nonvolatile manner. The memory 510 is configured with a semiconductor memory element such as a magnetic storage device or a flash ROM (Read Only Memory), or other types of nonvolatile storage devices. Furthermore, the memory 510 may include a RAM (Random Access Memory) that configures a work area of the processor 500. The memory 510 may also include nonvolatile storage devices such as an HDD (Hard Disk Drive) and an SSD (Solid State Drive). The memory 510 stores data to be processed by the processor 500 and a control program 511 executed by the processor 500.

To the vehicle control device 50, the first communication device 51, the second communication device 52, the charging station 53, and the position detection device 54 are connected.

The first communication device 51 is a device including a transmitter and a receiver for transmitting/receiving data with the management server 8, and performs wireless communication by a cellular communication system such as 3G (3rd Generation Mobile Communication System), 4G (4th Generation Mobile Communication System), LTE (Long Term Evolution), or 5G (5th Generation Mobile Communication System).

The second communication device 52 is a device that has a shorter communication range than that of the first communication device 51, and it is a device including a transmitter and a receiver that transmits/receives data with the power pack 2. The second communication device 52 performs wireless communication by a communication system such as Bluetooth.

The charging station 53 includes a holding unit 531 that holds the power pack 2 in a detachable manner, and an electrical unit 532 that houses various kinds of electric/electronic circuits. In the electrical unit 532, a charging station control device 533 and a charging device 534 are housed.

The holding unit 531 includes: a charging connector 535 that is electrically connected to an electrode of the power pack 2; and a lock mechanism 536 that makes it impossible to take out the power pack 2 in response to an instruction from the charging station control device 533. As the mechanism for making it impossible to take out the power pack 2, for example, the lock mechanism 536 includes an electric key that locks a lid body of the power pack outlet port formed inside the vehicle 5 to disable opening/closing, and an electrically-controlled locking mechanism that is latched to the power pack 2 housed in the holding unit 531 to make it impossible to be pulled out.

The charging station control device 533 is a device that controls each unit of the charging station 53, and includes a processor such as a CPU or an MPU, a memory, and an interface circuit for connecting other devices and sensors. Then, the processor executes the computer program stored in the memory to achieve various kinds of functions of the charging station 53.

The charging device 534 is a device that charges the power pack 2 by using the power supplied from an in-vehicle battery 55 loaded on the vehicle 5. The charging device 534 supplies the power to the power pack 2 held by the holding unit 531 according to a power supply instruction from the charging station control device 533. Note that the in-vehicle battery 55 may be a battery that is removable from the vehicle 5 or may be a battery that is not removable from the vehicle 5.

The position detection device 54 is a device that detects the current position of the vehicle 5, and includes a GNSS (Global Navigation Satellite System) receiver that receives positioning signals transmitted from a plurality of positioning satellites. The position detection device 54 outputs vehicle position information indicating the current position of the vehicle 5 to the vehicle control device 50.

The processor 500 functions as a first communication control unit 501 and a second communication control unit 502 by reading out and executing the control program 511 stored in the memory 510.

The first communication control unit 501 communicates with the management server 8 via the first communication device 51. The first communication control unit 501 transmits upload information to the management server 8.

The upload information contains battery information, vehicle position information, and the lessor ID (Identification) that uniquely identifies the lessor 3.

The battery information contains the battery ID that uniquely identifies the power pack 2 and charge amount information for each of the power packs 2 provided in the vehicle 5. For example, when there are three power packs 2 provided in the vehicle 5, the battery information contains a combination of the battery ID and the charge amount information for each of the three power packs 2.

The second communication control unit 502 communicates with the power pack 2 via the second communication device 52. The second communication control unit 502 receives the battery ID and the charge amount information from each of the power packs 2 provided in the vehicle 5.

### 1-3. Operations of Lessee Terminal

Next, the configuration of the lessee terminal 7 will be described.

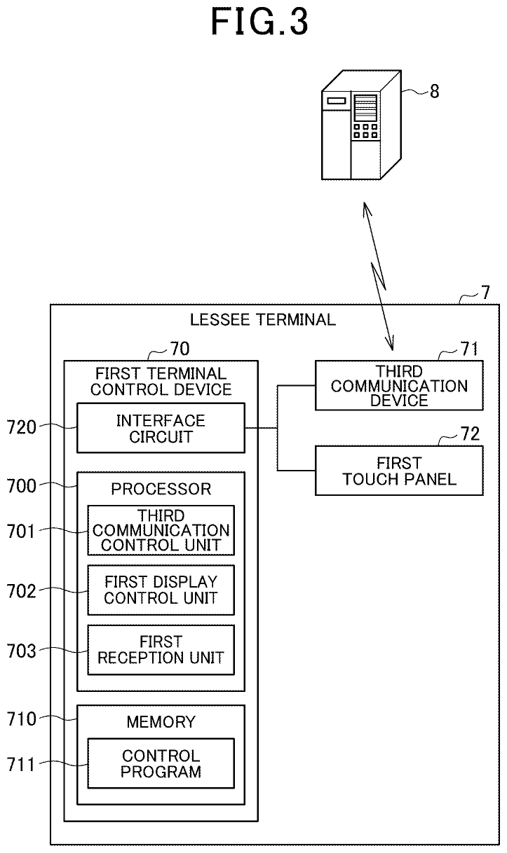

FIG. 3 is a diagram illustrating the configuration of the lessee terminal 7.

The lessee terminal 7 includes a first terminal control device 70, a third communication device 71, and a first touch panel 72.

The first terminal control device 70 is a device that controls each unit of the lessee terminal 7. The first terminal control device 70 includes a processor 700 such as a CPU or an MPU, a memory 710, and an interface circuit 720 to which other devices and sensors are connected.

The memory 710 is a storage device that stores a program and data to be executed by the processor 700 in a nonvolatile manner. The memory 710 is configured with a semiconductor memory element such as a magnetic storage device or a flash ROM, or other types of nonvolatile storage devices. Furthermore, the memory 710 may include a RAM that configures a work area of the processor 700. The memory 710 may also include nonvolatile storage devices such as an HDD and an SSD. The memory 710 stores data to be processed by the processor 700 and a control program 711 executed by the processor 700.

To the first terminal control device 70, the third communication device 71 and the first touch panel 72 are connected.

The third communication device 71 is a device that includes a transmitter and a receiver for transmitting/receiving data with the management server 8. The third communication device 71 is a wireless communication device.

The first touch panel 72 has a configuration in which a liquid crystal display panel that displays characters and images is superimposed with a touch sensor that detects contact made on the liquid crystal display panel.

The processor 700 functions as a third communication control unit 701, a first display control unit 702, and a first reception unit 703 by reading out and executing the control program 711 stored in the memory 710.

The third communication control unit 701 communicates with the management server 8 via the third communication device 71.

The first display control unit 702 displays information on the first touch panel 72.

The first reception unit 703 receives operations made on the first touch panel 72.

### 1-4. Operations of Lessor Terminal

Next, the configuration of the lessor terminal 6 will be described.

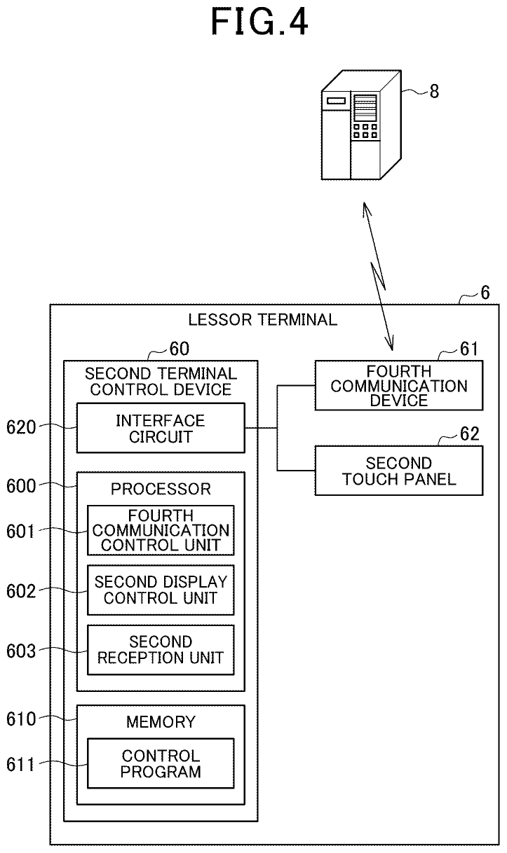

FIG. 4 is a diagram illustrating the configuration of the lessor terminal 6.

The lessor terminal 6 includes a second terminal control device 60, a fourth communication device 61, and a second touch panel 62.

The second terminal control device 60 is a device that controls each unit of the lessor terminal 6. The second terminal control device 60 includes a processor 600 such as a CPU or an MPU, a memory 610, and an interface circuit 620 to which other devices and sensors are connected.

The memory 610 is a storage device that stores a program and data to be executed by the processor 600 in a nonvolatile manner. The memory 610 is configured with a semiconductor memory element such as a magnetic storage device or a flash ROM, or other types of nonvolatile storage devices. Furthermore, the memory 610 may include a RAM that configures a work area of the processor 600. The memory 610 may also include nonvolatile storage devices such as an HDD and an SSD. The memory 610 stores data to be processed by the processor 600 and a control program 611 executed by the processor 600.

To the second terminal control device 60, the fourth communication device 61 and the second touch panel 62 are connected.

The fourth communication device 61 is a device that includes a transmitter and a receiver for transmitting/receiving data with the management server 8. The fourth communication device 61 is a wireless communication device.

The second touch panel 62 has a configuration in which a liquid crystal display panel that displays characters and images is superimposed with a touch sensor that detects contact made on the liquid crystal display panel.

The processor 600 functions as a fourth communication control unit 601, a second display control unit 602, and a second reception unit 603 by reading out and executing the control program 611 stored in the memory 610.

The fourth communication control unit 601 communicates with the management server 8 via the fourth communication device 61.

The second display control unit 602 displays information on the second touch panel 62.

The second reception unit 603 receives operations made on the second touch panel 62.

### 1-5. Configuration of Management Server

Next, the configuration of the management server 8 will be described.

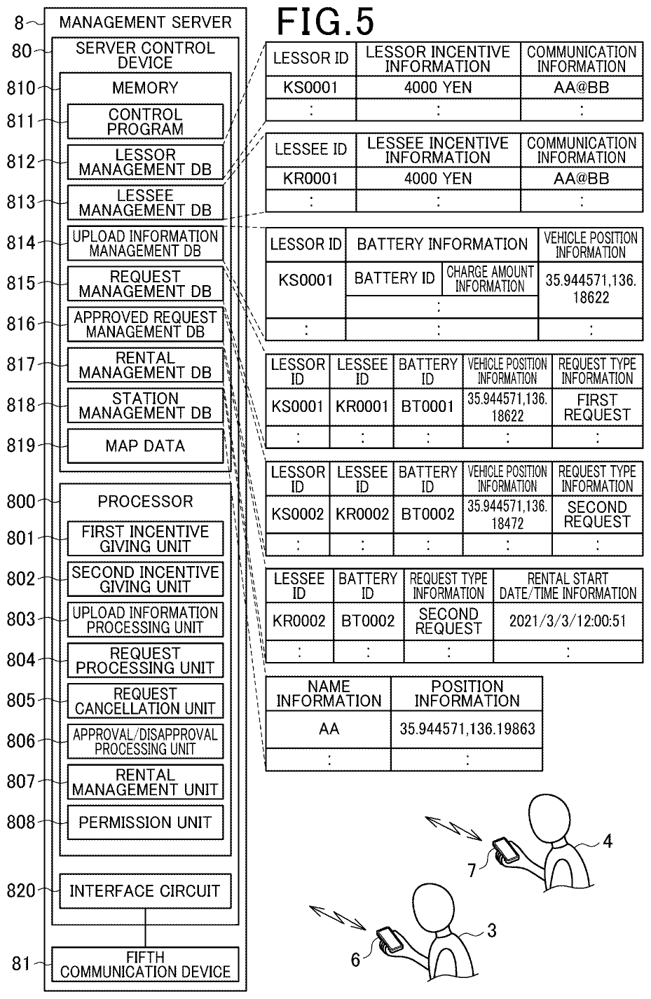

FIG. 5 is a diagram illustrating the configuration of the management server 8.

The management server 8 includes a server control device 80 and a fifth communication device 81.

The server control device 80 is a device that controls each unit of the management server 8. The server control device 80 includes a processor 800 such as a CPU or an MPU, a memory 810, and an interface circuit 820 to which the fifth communication device 81 is connected.

The memory 810 is a storage device that stores a program and data to be executed by the processor 800 in a nonvolatile manner. The memory 810 is configured with a semiconductor memory element such as a magnetic storage device or a flash ROM, or other types of nonvolatile storage devices. Furthermore, the memory 810 may include a RAM that configures a work area of the processor 800. The memory 810 may also include nonvolatile storage devices such as an HDD and an SSD. The memory 810 stores data to be processed by the processor 800, a control program 811 executed by the processor 800, a lessor management DB (database) 812, a lessee management DB 813, an upload information management DB 814, a request management DB 815, an approved request management DB 816, a rental management DB 817, a station management DB 818, and map data 819.

The lessor management DB 812 stores, for each of the lessors 3, a record containing information regarding the lessor 3. The information regarding the lessor 3 contains the lessor ID, lessor incentive information that is the information of the incentive given to the lessor 3, and communication information for communicating with the lessor terminal 6. As the communication information, an example thereof may include address information. The incentive may be money or a discount coupon.

The lessee management DB 813 stores, for each of the lessees 4, a record containing information regarding the lessee 4. The information regarding the lessee 4 contains the lessee ID that uniquely identifies the lessee 4, lessee incentive information that is the information of the incentive given to the lessee 4, and communication information for communicating with the lessee terminal 7.

The upload information management DB 814 stores, for each piece of upload information, a record that carries the upload information.

The request management DB 815 stores, for each request to rent the power pack 2 (hereinafter, referred to as “rental request”), a record containing information regarding the rental request. The information regarding the rental request contains the lessor ID, the lessee ID, the battery ID, vehicle position information, and request type information. The request type information is the information indicating the type of rental request. The types of rental request will be described later.

The approved request management DB 816 stores, for each of the rental requests approved to rent the power pack 2, a record containing the information regarding the rental request.

The rental management DB 817 stores, for each of the power packs 2 rented by the lessee 4, a record containing the information regarding rental of the power pack 2. The information regarding rental of the power pack 2 contains the lessee ID, the battery ID, the request type information, and rental start date/time information. The rental start date/time information is the information indicating the date/time at which rental of the power pack 2 is started.

The station management DB 818 stores, for each of the stations ST, a record containing information regarding the station ST. The information regarding the station ST contains the name information of the station ST and the position information of the station ST.

The map data 819 is data carrying road map information, facility information of various facilities and the like, map matching data, and the like. The road map information is configured with a road network in which roads on the map are expressed with lines, and contains information regarding links each connecting between nodes that are intersections, branch points, and the like used to divide a road into a plurality of sections. The facility information indicates the position (latitude, longitude) of the facility, the name of the facility, an image of the facility, and the like. The map data 819 contains image data of the map.

The fifth communication device 81 is a device that includes a transmitter and a receiver for transmitting/receiving data with the vehicle 5, the lessor terminal 6, and the lessee terminal 7. The fifth communication device 81 may be a wired communication device or a wireless communication device.

The processor 800 functions as a first incentive giving unit 801, a second incentive giving unit 802, an upload information processing unit 803, a request processing unit 804, a request cancellation unit 805, an approval/disapproval processing unit 806, a rental management unit 807, and a permission unit 808 by reading out and executing the control program 811 stored in the memory 810.

The request processing unit 804 corresponds to a request reception unit of the present disclosure. The approval/disapproval processing unit 806 corresponds to an approval reception unit of the present disclosure.

The first incentive giving unit 801 gives an incentive to the lessor 3. Specifically, the first incentive giving unit 801 specifies the lessor incentive information of the lessor 3 as the target recipient from the lessor management DB 812 based on the lessor ID. Then, the first incentive giving unit 801 updates the incentive indicated by the specified lessor incentive information to an incentive to which the incentive of the target recipient is added.

The second incentive giving unit 802 gives an incentive to the lessee 4. Specifically, the second incentive giving unit 802 specifies the lessee incentive information of the lessee 4 as the target recipient from the lessee management DB 813 based on the lessee ID. Then, the second incentive giving unit 802 updates the incentive indicated by the lessee incentive information to an incentive to which the incentive of the target recipient is added.

The upload information processing unit 803 receives upload information via the fifth communication device 81. The upload information processing unit 803 processes the received upload information. Specific processing will be described later.

The request processing unit 804 receives a rental request from the lessee 4. Specifically, the request processing unit 804 receives rental request information indicating a rental request from the lessee terminal 7 via the fifth communication device 81. In the embodiment, as the rental request, there are a first request and a second request. The first request is a rental request without returning of the power pack 2 to the lessor 3. The second request is a rental request with returning of the power pack 2 to the lessor 3. The request processing unit 804 receives the first request or the second request by receiving first request information indicating the first request or second request information indicating the second request.

The request cancellation unit 805 cancels the rental request received by the request processing unit 804.

The approval/disapproval processing unit 806 receives, from the lessor 3, an approval for the rental request received by the request processing unit 804 or a disapproval for the rental request received by the request processing unit 804. Specifically, the approval/disapproval processing unit 806 receives approval information indicating an approval or disapproval information indicating a disapproval from the lessor terminal 6 via the fifth communication device 81.

The rental management unit 807 manages the power pack 2 rented by the lessee 4.

The permission unit 808 permits the lessor 3 to bring out the power pack 2 from the station ST. Specifically, the permission unit 808 permits the lessor 3 to bring out the power pack 2 by transmitting permission information to the lessor terminal 6 via the fifth communication device 81. The permission information is information indicating a permission to bring out the power pack 2 from the station ST.

### 1-6. Operations of Each Unit of Rental System

Next, operations of each unit of the rental system 1 will be described.

For renting the power pack 2, the lessee terminal 7 displays a rental request screen KG to be described later, and the lessee 4 operates the displayed rental request screen KG to make a rental request to the lessor 3. The management server 8 generates image data of the rental request screen KG by using the upload information stored in the upload information management DB 814, and transmits the generated image data of the rental request screen KG to the lessee terminal 7. The management server 8 performs generation of the rental request screen KG and transmission of the image data of the rental request screen KG, when a prescribed trigger occurs. As the prescribed trigger, examples thereof include that the upload information management DB 814 is updated, and that a prescribed period has passed.

First, the operations of each of the units of the rental system 1 related to the upload information will be described.

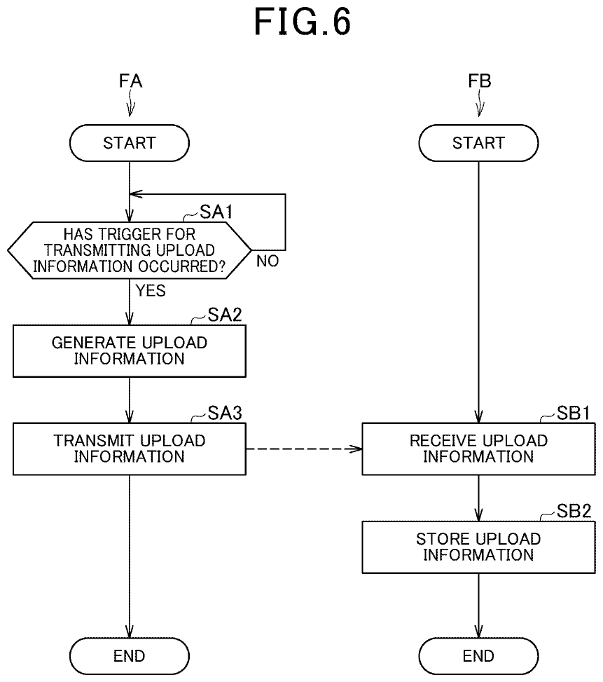

FIG. 6 illustrates flowcharts of the operations of the rental system 1. In FIG. 6, the flowchart FA indicates the operation of the vehicle 5, and the flowchart FB indicates the operation of the management server 8.

As indicated in the flowchart FA, the first communication control unit 501 determines whether or not a trigger has occurred for transmitting the upload information (Step SA1). As the trigger, examples thereof include that a prescribed time (for example, 10 minutes) has passed after previous transmission of the upload information, that an ignition of the vehicle 5 is turned on, and that the ignition of the vehicle 5 is turned off.

When it is determined that a trigger has occurred for transmitting upload information (YES in Step SA1), the first communication control unit 501 generates the upload information (Step SA2).

In Step SA2, the first communication control unit 501 acquires, from the second communication device 52, a combination of the battery ID and the charge amount information received by the second communication device 52. Furthermore, the first communication control unit 501 acquires the vehicle position information from the position detection device 54. The first communication control unit 501 also acquires the lessor ID from the memory 510. The first communication control unit 501 generates the upload information containing such acquired information.

Note that the lessor ID is stored in advance in the memory 510 at a prescribed timing.

Returning to the flowchart FA, the first communication control unit 501 transmits the generated upload information to the management server 8 (Step SA3).

As indicated in the flowchart FB, the upload information processing unit 803 receives the upload information from the vehicle 5 (Step SB1).

Then, the upload information processing unit 803 stores the upload information received in Step SB1 to the upload information management DB 814 (Step SB2).

In Step SB2, when the upload information having the lessor ID same as the lessor ID contained in the upload information received in Step SB1 exists in the upload information management DB 814, the upload information processing unit 803 updates the upload information having the same lessor ID to the upload information received in Step SB1.

Next, flowcharts indicating the operations of the rental system 1 related to a rental request will be described.

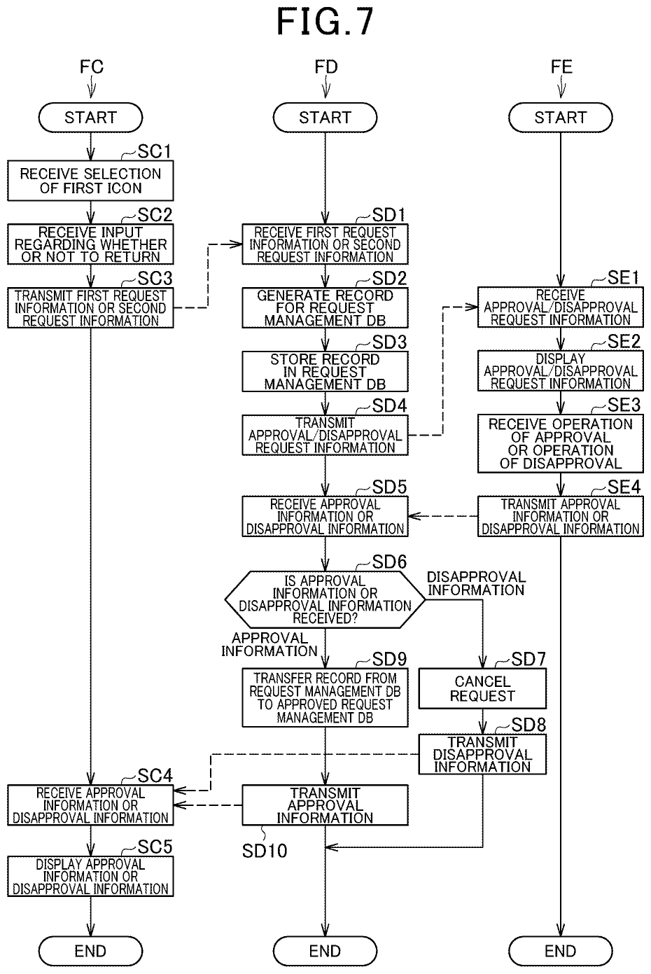

FIG. 7 illustrates the flowcharts indicating the operations of the rental system 1. In FIG. 7, the flowchart FC indicates the operation of the lessee terminal 7, the flowchart FD indicates the operation of the management server 8, and the flowchart FE indicates the operation of the lessor terminal 6.

At the point of the start of the flowchart FC, the first display control unit 702 displays the rental request screen KG on the first touch panel 72. The rental request screen KG is a screen for requesting rental of the power pack 2.

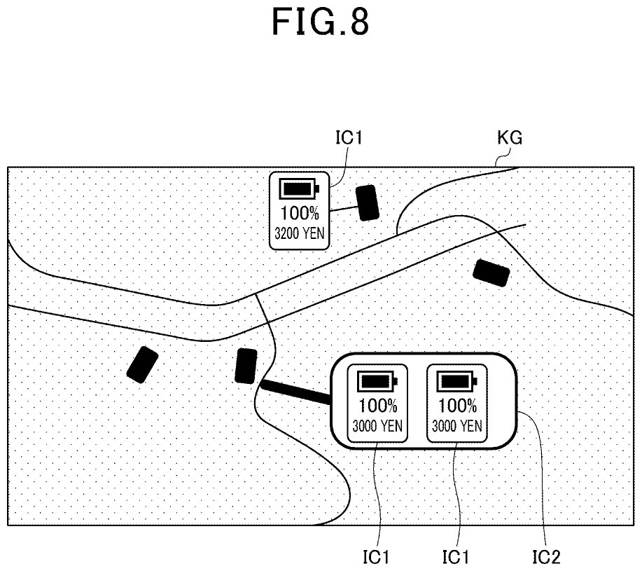

FIG. 8 is a diagram illustrating an example of the rental request screen KG.

The rental request screen KG is a screen displaying a map and first icons IC1 superimposed on the map. The rental request screen KG displays a single first icon IC1 for each of the power packs 2 located on the map. The first icon IC1 includes information of the charge amount for the corresponding power pack 2 and information of the fee for renting the power pack 2. The first icon IC1 is displayed at the position on the map corresponding to the current position of the corresponding power pack 2. When a plurality of first icons IC1 are displayed at a same position, the rental request screen KG displays a second icon IC2 that includes those first icons IC1. The second icon IC2 is displayed at the position on the map corresponding to the current position of the power pack 2 corresponding to the included first icons IC1.

When the current position of the corresponding power pack 2 changes, the displayed position of the first icon IC1 on the rental request screen KG changes. Furthermore, the charge amount indicated in the first icon IC1 changes when the charge amount of the corresponding power pack 2 changes. Moreover, the fee indicated in the first icon IC1 changes as appropriate when the current position of the corresponding power pack 2 changes.

As described above, when a prescribed trigger occurs, the management server 8 generates the rental request screen KG, and transmits the image data of the generated rental request screen KG to the lessee terminal 7. The management server 8 generates the rental request screen KG by referring to the record stored in the upload information management DB 814, the record stored in the station management DB 818, and the map data 819. For generating the rental request screen KG, the management server 8 generates the first icon IC1 and displays the first icon IC1 on the map for each of the battery IDs contained in the upload information based on various kinds of information associated with the corresponding battery ID. Note that the management server 8 of the embodiment generates the rental request screen KG by having the current position of the vehicle 5 as the current position of the power pack 2.

The management server 8 determines the fee indicated in the first icon IC1 according to the separation distance between the current position of the power pack 2 and the position of the nearby station ST from the current position of the power pack 2. The fee indicated in the first icon IC1 is the fee that is acquired by adding the fee corresponding to the separation distance to the basic fee.

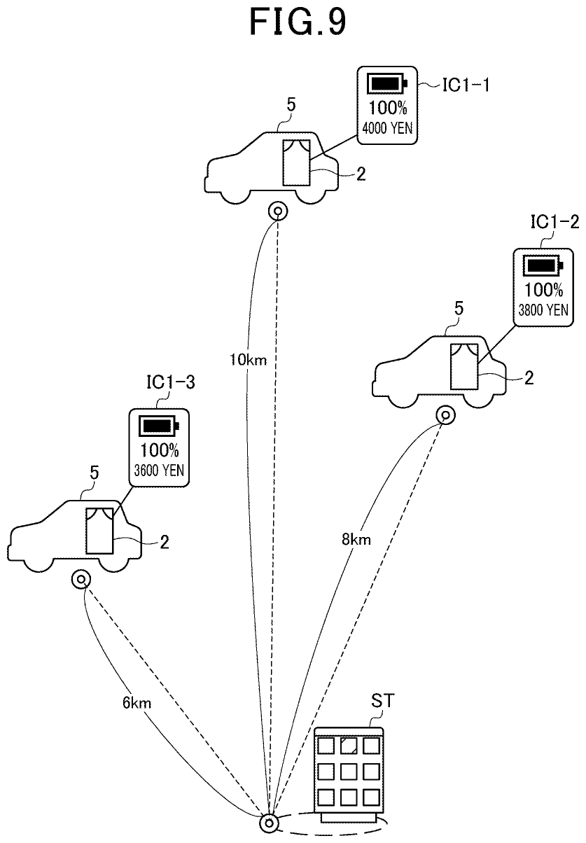

FIG. 9 is a diagram illustrating an example of the fees indicated in the first icons IC1.

In FIG. 9, three first icons IC1 are illustrated. In the case of FIG. 9, it is assumed that the current position of the power pack 2 corresponding to the first icon IC1-1 and the position of the station ST are separated by 10 km. In the case of FIG. 9, it is assumed that the current position of the power pack 2 corresponding to the first icon IC1-2 and the position of the station ST are separated by 8 km. In the case of FIG. 9, it is assumed that the current position of the power pack 2 corresponding to the first icon IC1-3 and the position of the station ST are separated by 6 km.

In the case of FIG. 9, it is assumed that the basic fee is 3000 yen, and a fee of 200 yen is added for every 2 km of distance away from the station ST. Therefore, in the case of FIG. 9, the first icon IC1-1 indicates the fee as 4000 yen, the first icon IC1-2 indicates the fee as 3800 yen, and the first icon IC1-3 indicates the fee as 3600 yen.

Returning to the flowchart FC, the first reception unit 703 receives selection of the first icon IC1 in the rental request screen KG displayed on the first touch panel 72 (Step SC1).

Then, the first reception unit 703 receives input regarding whether or not to return the power pack 2 to the lessor 3 after the rental (Step SC2).

Then, the third communication control unit 701 transmits the first request information or the second request information to the management server 8 (Step SC3).

The first request information and the second request information contain the battery ID corresponding to the first icon IC1 selected in Step SC1, the lessor ID of the lessor who rents out the power pack 2 having the battery ID, and the lessee ID stored in the memory 710 are included. For each of the first icons IC1, the battery ID of the corresponding power pack 2 is linked and written in the image data of the rental request screen KG. Furthermore, for each of the first icons IC1, the lessor ID of the lessor 3 who rents out the corresponding power pack 2 is linked and written in the image data of the rental request screen KG. The lessee ID is stored in advance in the memory 710 at a prescribed timing.

When the first reception unit 703 receives input in Step SC2 indicating that the power pack 2 is not to be returned, the third communication control unit 701 transmits the first request information in Step SC3. When the first reception unit 703 receives input in Step SC2 indicating that the power pack 2 is to be returned, the third communication control unit 701 transmits the second request information in Step SC3.

As indicated in the flowchart FE, the request processing unit 804 receives the first request information or the second request information from the lessee terminal 7 (Step SE1). At this point, the fee for renting the power pack 2 is tentatively confirmed. That is, tentative confirmation is made such that there is no change occurred in the fee checked by the lessee 4, which may be caused because, after the lessee 4 selects the first icon SC1, the fee fluctuates due to traveling of the lessor 3 from the amount at the time when the first request information or the second request information is transmitted.

Then, the request processing unit 804 generates a record to be stored in the request management DB 815 (Step SE2).

In Step SE2, the request processing unit 804 specifies the upload information containing the battery ID that is contained in the first request information or the second request information from the upload information management DB 814, and acquires the vehicle position information contained in the specified upload information. Then, the request processing unit 804 generates a record containing the battery ID, the lessor ID, and the lessee ID contained in the first request information or the second request information, the acquired vehicle position information, and request type information indicating whether it is the first request information or the second request information.

Then, the request processing unit 804 stores the record generated in Step SE2 to the request management DB 815 (Step SE3).

Then, the request processing unit 804 transmits the approval/disapproval request information to the lessor terminal 6 (Step SE4). The approval/disapproval request information is information for requesting an approval or a disapproval for the rental request received in Step SE1 to the lessor 3. The approval/disapproval request information contains the lessor ID, the lessee ID, and the battery ID contained in the first request information or the second request information received in Step SE1. In Step SE4, the request processing unit 804 specifies communication information corresponding to the lessor ID contained in the first request information or the second request information from the lessor management DB 812, and transmits the approval/disapproval request information to the lessor terminal 6 based on the specified communication information.

As indicated in the flowchart FE, the fourth communication control unit 601 receives the approval/disapproval request information from the management server 8 (Step SE1).

Then, the second display control unit 602 displays the approval/disapproval request information received in Step SE1 (Step SE2).

The second reception unit 603 receives an operation of approval or an operation of disapproval for the request indicated by the approval/disapproval request information displayed in Step SE2 (Step SE3).

The fourth communication control unit 601 transmits approval information indicating that the rental request is approved or disapproval information indicating that the rental request is disapproved (Step SE4). The fourth communication control unit 601 transmits the approval information when the second reception unit 603 receives the operation of approval in Step SE3, and transmits the disapproval information when the second reception unit 603 receives the operation of disapproval in Step SE3.

The approval information and the disapproval information contain the lessor ID, the lessee ID, and the battery ID contained in the approval/disapproval request information received in Step SE1.

As indicated in the flowchart FD, the approval/disapproval processing unit 806 receives the approval information or the disapproval information (Step SD5).

The approval/disapproval processing unit 806 determines whether the approval information is received or the disapproval information is received (Step SD6).

When the approval/disapproval processing unit 806 determines that the disapproval information is received (Step SD6: disapproval information), the request cancellation unit 805 cancels the rental request received by the request processing unit 804 in Step SD1 (Step SD7). Describing Step SD7 in more detail, the request cancellation unit 805 specifies the record containing the battery ID contained in the disapproval information from the request management DB 815, and erases the specified record from the request management DB 815.

Then, the approval/disapproval processing unit 806 transmits the disapproval information to the lessee terminal 7 (Step SD8). In Step SD8, the approval/disapproval processing unit 806 specifies the communication information corresponding to the lessee ID contained in the disapproval information from the lessee management DB 813, and transmits the disapproval information to the lessee terminal 7 based on the specified communication information.

Returning to Step SD6, when it is determined that the approval information is received (Step SD6: approval information), the approval/disapproval processing unit 806 transfers the record containing the battery ID contained in the approval information from the request management DB 815 to the approved request management DB 816 (Step SD9). In addition, in this step, the fee tentatively confirmed at the point of Step SE1 is confirmed.

Then, the approval/disapproval processing unit 806 transmits the approval information to the lessee terminal 7 (Step SD10). In Step SD10, the approval/disapproval processing unit 806 specifies the communication information corresponding to the lessee ID contained in the approval information from the lessee management DB 813, and transmits the approval information to the lessee terminal 7 based on the specified communication information.

As indicated in the flowchart FC, the third communication control unit 701 receives the approval information or the disapproval information from the management server 8 (Step SC4).

Then, the first display control unit 702 displays the approval information or the disapproval information received in Step SC4 on the first touch panel 72 (Step SC5). Thereby, the lessee 4 can check whether or not the lessor 3 has approved the rental request.

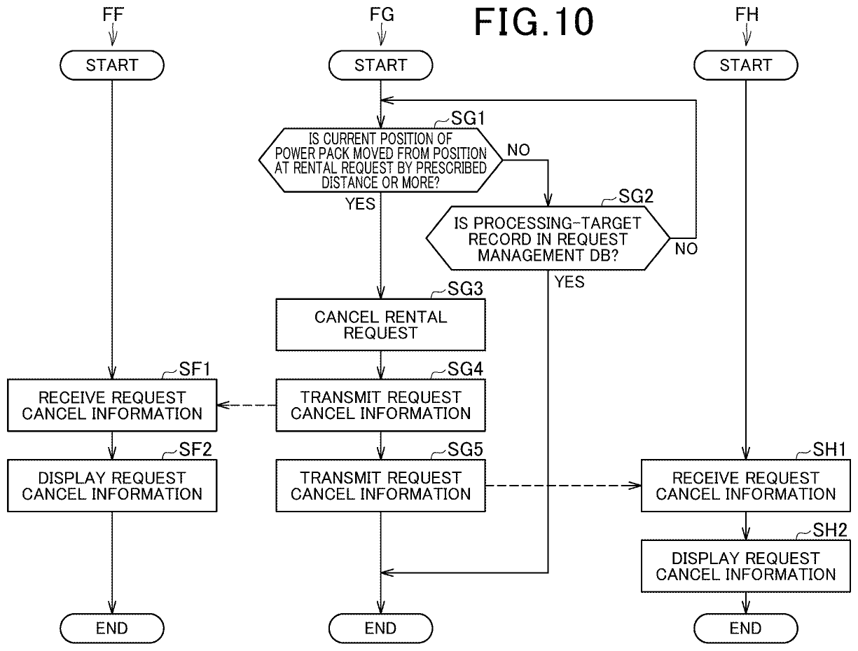

The rental system 1 performs the operations illustrated in FIG. 10 during the period after the lessee 4 makes a rental request until the lessor 3 gives an approval.

FIG. 10 illustrates flowcharts indicating the operations of the rental system 1. In FIG. 10, the flowchart FF indicates the operation of the lessee terminal 7, the flowchart FG indicates the operation of the management server 8, and the flowchart FH indicates the operation of the lessor terminal 6.

The operation of the flowchart FG is the operation targeted at a single record stored in the request management DB 815. The management server 8 performs the operation of the flowchart FG for each of the records stored in the request management DB 815.

The request cancellation unit 805 determines whether or not the current position of the power pack 2 corresponding to the processing-target record has moved by a prescribed distance or more from the position at which the lessee 4 made the rental request (Step SG1).

Step SG1 will be described in detail.

The request cancellation unit 805 specifies the upload information having the battery ID same as the battery ID contained in the processing-target record from the upload information management DB. Then, by having the current position of the power pack 2 as the current position of the vehicle 5, the request cancellation unit 805 calculates the separation distance between the current position of the vehicle 5 indicated by the vehicle position information contained in the specified upload information and the position of the vehicle 5 indicated by the vehicle position information contained in the processing-target record. Then, the request cancellation unit 805 determines positive in Step SG1 when the calculated separation distance is equal to or more than the prescribed distance, and determines negative in Step SG1 when the calculated separation distance is less than the prescribed distance.

When it is determined that the current position of the power pack 2 has not moved by the prescribed distance or more (NO in Step SG1), the request cancellation unit 805 determines whether or not the processing-target record is in the request management DB 815 (Step SG2).

When it is determined that the processing-target record is in the request management DB 815 (YES in Step SG2), the request cancellation unit 805 ends the present processing.

In the meantime, when it is determined that the processing-target record is not in the request management DB 815 (NO in Step SG2), the request cancellation unit 805 performs determination of Step SG1 again.

Returning to Step SG1, when it is determined that the current position of the power pack 2 has moved by the prescribed distance or more (YES in Step SG1), the request cancellation unit 805 cancels the rental request corresponding to the processing-target record (Step SG3). That is, in Step SG3, the request cancellation unit 805 erases the processing-target record from the request management DB 815.

The request cancellation unit 805 transmits the request cancel information indicating that the rental request is canceled to the lessee terminal 7 via the fifth communication device 81 (Step SG4). The request cancel information contains the battery ID contained in the erased record.

As indicated in the flowchart FF, the third communication control unit 701 receives the request cancel information (Step SF1). Then, the first display control unit 702 displays the received request cancel information on the first touch panel 72 (Step SF2).

Returning to the flowchart FG, the request cancellation unit 805 transmits the request cancel information to the lessor terminal 6 via the fifth communication device 81 (Step SG5).

As indicated in the flowchart FH, the fourth communication control unit 601 receives the request cancel information (Step SH1). Then, the second display control unit 602 displays the received request cancel information on the second touch panel 62 (Step SH2).

Next, the operation of the management server 8 related to giving an incentive to the lessor 3 will be described.

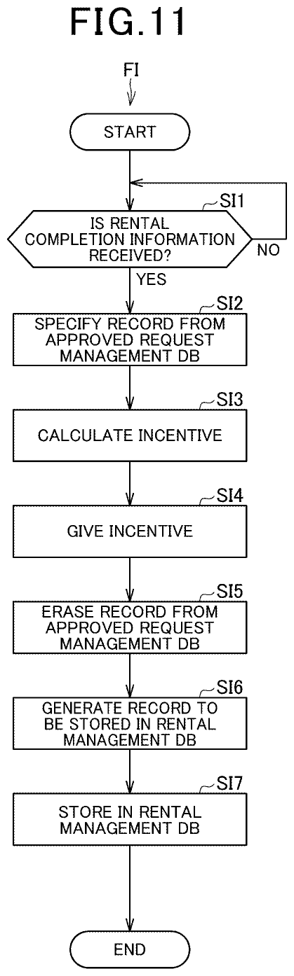

FIG. 11 illustrates the flowchart FI indicating the operation of the management server 8.

The first incentive giving unit 801 determines whether or not rental completion information indicating the power pack 2 is rented out is received (Step SI1). The rental completion information may be transmitted from the lessee terminal 7 or may be transmitted from the lessor terminal 6. The rental completion information contains the battery ID of the power pack 2 that is rented out.

When it is determined that the rental completion information is received (YES in Step SI1), the first incentive giving unit 801 specifies the record containing the battery ID that is contained in the rental completion information from the approved request management DB 816 (Step SI2).

Then, the first incentive giving unit 801 calculates the incentive to be given to the lessor 3 based on the record specified in Step SI2 (Step SI3).

Step SI3 will be described in detail.

By having the current position of the vehicle 5 indicated by the vehicle position information of the record specified in Step SI2 as the current position of the power pack 2, the first incentive giving unit 801 acquires the position information of the station ST closest to the current position of the power pack 2 from the station management DB 818. Then, the first incentive giving unit 801 calculates the separation distance between the position of the station ST indicated by the acquired position information and the current position of the vehicle 5 considered as the current position of the power pack 2. Thereafter, the first incentive giving unit 801 calculates the incentive corresponding to the calculated separation distance. The first incentive giving unit 801 calculates the incentive to be higher as the calculated separation distance is longer. When the incentive is money, the first incentive giving unit 801 calculates the incentive by a same arithmetic operation as that of the fee indicated in the first icon IC1. Thereby, the same amount of money as that of the fee the lessee 4 has paid is given to the lessor 3.

Then, the first incentive giving unit 801 gives the calculated incentive to the lessor 3 (Step SI4).

Then, the rental management unit 807 erases the record specified in Step SI2 from the approved request management DB 816 (Step SI5).

Then, the rental management unit 807 generates a record to be stored in the rental management DB 817 (Step SI6). In Step SI6, the rental management unit 807 generates a record containing the various kinds of information contained in the record erased in Step SI5 and the start date/time information indicating the date/time at which rental of the power pack 2 is started.

Then, the rental management unit 807 stores the record generated in Step SI5 to the rental management DB 817 (Step SI7).

Next, the operations of the management server 8 after the power pack 2 is rented out will be described. The operations will be described separately by referring to a case where the power pack 2 is rented out without returning thereof to the lessor 3 and to a case where the power pack 2 is rented out with returning thereof to the lessor 3.

First, the operation of the management server 8 when performing rental of the power pack 2 without returning thereof to the lessor 3 will be described.

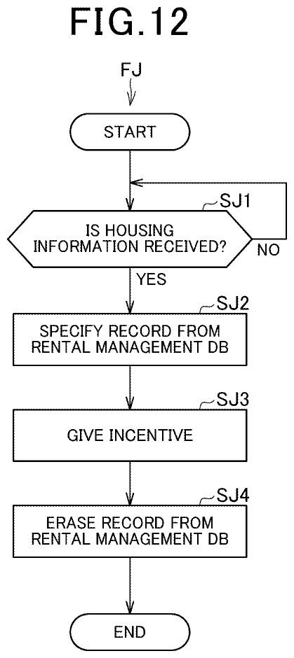

FIG. 12 illustrates the flowchart FJ indicating the operation of the management server 8.

The second incentive giving unit 802 determines whether or not housing information indicating that the power pack 2 is housed in the station ST is received (Step SJ1). The housing information contains the battery ID of the power pack 2 housed in the station ST. The second incentive giving unit 802 may receive the housing information from the lessee terminal 7 or from the communication device set at the station ST.

When it is determined that the housing information is received (YES in Step SI1), the second incentive giving unit 802 refers to the rental management DB 817, and specifies the record containing the battery ID of the housing information (Step SI2).

Then, the second incentive giving unit 802 gives an incentive to the lessee 4 specified by the lessee ID contained in the record specified in Step SI2 (Step SI3). In the embodiment, the incentive given to the lessee 4 may be an incentive of a fixed value or may be an incentive whose value changes due to a prescribed factor. When the incentive is money, the second incentive giving unit 802 gives 2800 yen to the lessee 4, for example. Note here that when the lessee 4 rents the power pack 2 from the lessor 3 for 3000 yen, the lessee 4 in the end comes to pay 200 yen to the provider or the like of the rental system 1 as the power usage fee.

Then, the rental management unit 807 erases the record specified in Step SI2 from the rental management DB 817 (Step SI4).

Next, the operation of the management server 8 when performing rental of the power pack 2 with returning thereof to the lessor 3 will be described.

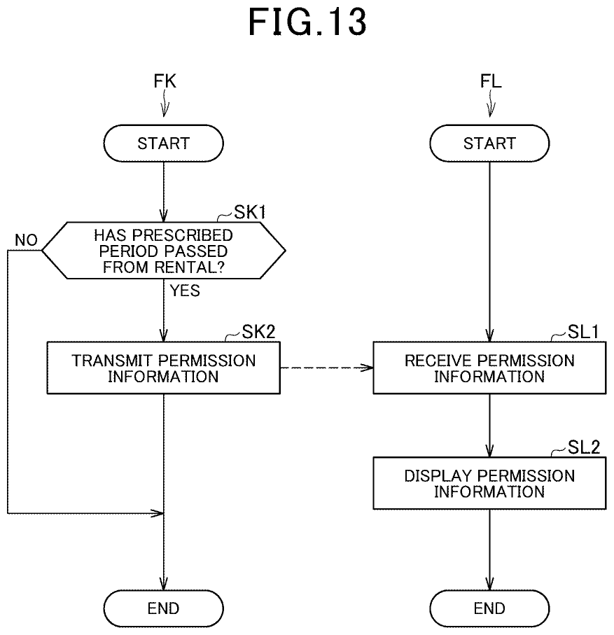

FIG. 13 illustrates flowcharts indicating the operations of the rental system 1. In FIG. 13, the flowchart FK indicates the operation of the management server 8, and the flowchart FL indicates the operation of the lessor terminal 6.

As for the operation of the flowchart FK, the record whose request type information indicates the second request is the processing target.

As indicated in the flowchart FK, the permission unit 808 determines whether or not a prescribed period (for example, one day) has passed after the power pack 2 corresponding to the processing-target record is rented out (Step SK1).

Step SK1 will be described in detail.

With the start date/time indicated by the start date/time information contained in the processing-target record being the basis, when the current date/time indicates the date/time that has passed the prescribed period from the basis, the permission unit 808 determines positive in Step SK1.

When it is determined that the prescribed period has not passed after the power pack 2 is rented out, the permission unit 808 ends the present processing.

In the meantime, when it is determined that the prescribed period or more has passed after the power pack 2 is rented out (YES in Step SK1), the permission unit 808 transmits permission information to the lessor terminal 6 via the fifth communication device 81 (Step SK2). In Step SK2, the permission unit 808 transmits the permission information to the lessor terminal 6 based on the communication information corresponding to the lessor ID contained in the processing-target record.

As indicated in the flowchart FL, the fourth communication control unit 601 receives the permission information from the management server 8 (Step SL1). Then, the second display control unit 602 displays the permission information received in Step SL1 on the second touch panel 62 (Step SL2).

### 2. Second Embodiment

The first embodiment described above is configured to give the incentive to the lessor 3 according to the separation distance between the current position of the power pack 2 at the point when the lessee 4 makes a rental request and the position of the nearby station ST. In the second embodiment, the incentive given to the lessor 3 may vary according to the charge amount of the power pack 2 at the point when the lessee 4 makes the rental request, in addition to the separation distance.

For example, in the second embodiment, the lower the charge amount of the power pack 2, the lower the incentive to be given to the lessor 3. Furthermore, in the second embodiment, the lessee 4 can rent the power pack 2 for the fee corresponding to the charge amount of the power pack 2 at the point when the rental request is made. For example, in the second embodiment, the less the charge amount of the power pack 2, the lower the fee for which the lessee 4 can rent the power pack 2.

The management server 8 of the second embodiment generates the image data of the rental request screen KG where the first icon IC1 indicating the fee upon which the charge amount of the power pack 2 is reflected is displayed, and transmits the generated image data to the lessee terminal 7.

The request processing unit 804 and the approval/disapproval processing unit 806 of the second embodiment store, in a target database, the record containing the information regarding the charge amount of the power pack 2 at the point when the rental request for the power pack 2 is made. Then, the first incentive giving unit 801 refers to the information regarding the charge amount of the power pack 2 contained in the record, and gives an incentive to the lessor 3 according to the charge amount of the power pack 2. For example, when the incentive is money, the first incentive giving unit 801 gives, to the lessor 3, the amount corresponding to fee paid by the lessee 4, that is, the fee acquired by subtracting the amount corresponding to the charge amount of the power pack 2 from the basic fee and the additional fee.

### 3. Third Embodiment

The first embodiment described above is configured to designate whether or not to return the power pack 2, when the lessee 4 makes a rental request. In the third embodiment, the lessee 4 can designate the place to rent the power pack 2, when making a rental request. Hereinafter, a rental request with a designated place for renting the power pack 2 is referred to as a third request.

In the third embodiment, the first reception unit 703 receives input of the place to rent the power pack 2. In the third embodiment, the third communication control unit 701 transmits, to the management server 8, third request information indicating the third request with the designated place received by the first reception unit 703. The information in the third request information contains the information regarding the place received by the first reception unit 703 and various kinds of information contained in the first request information and the second request information.

The request processing unit 804 and the approval/disapproval processing unit 806 of the third embodiment store, in the target database, the record that further contains the information regarding the place received by the first reception unit 703. Then, when the record to be referred contains the information regarding the place, the first incentive giving unit 801 increases the incentive to be given to the lessor 3 compared to a case where the record to be referred does not contain the information regarding the place. For example, when the incentive is money, the management server 8 of the third embodiment gives, to the lessor 3, the fee paid by the lessee 4, that is, the amount acquired by adding the amount corresponding to a delivery fee to the basic fee and the additional fee.

### 4. Fourth Embodiment

The first embodiment described above is configured to designate to return the power pack 2, when the lessee 4 makes a rental request. In the fourth embodiment, the lessee 4 can designate the amount of electricity to be used and the use time, when making a second request. Hereinafter, the second request with a designated amount of electricity to be used and use time is referred to as a fourth request.

In the fourth embodiment, the lessee 4 can rent the power pack 2 for the amount corresponding to the amount of electricity to be used and the use time. For example, in the fourth embodiment, the less the amount of electricity to be used, the lower the fee for which the power pack 2 can be rented. Furthermore, the shorter the use time, the lower the fee for which the power pack 2 can be rented.

In the fourth embodiment, the first reception unit 703 receives input of the amount of electricity to be used and the use time. In the fourth embodiment, the third communication control unit 701 transmits, to the management server 8, fourth request information indicating the fourth request with the designated amount of electricity and use time received by the first reception unit 703. The information in the fourth request information contains the information regarding the amount of electricity and the use time received by the first reception unit 703 and various kinds of information contained in the first request information and the second request information.

The request processing unit 804 and the approval/disapproval processing unit 806 of the fourth embodiment store, in the target database, the record that further contains the information regarding the amount of electricity and the use time received by the first reception unit 703. Then, when the record to be referred contains the information regarding the amount of electricity and the use time, the first incentive giving unit 801 varies the incentive to be given to the lessor 3 compared to a case where the record to be referred does not contain the information regarding the amount of electricity and the use time. For example, the less the amount of electricity, the smaller the incentive to be given to the lessor 3, and the shorter the use time, the smaller the incentive to be given to the lessor 3. For example, when the incentive is money, the first incentive giving unit 801 gives, to the lessor 3, the amount corresponding to the fee paid by the lessee 4 (the fee acquired by subtracting larger amount as the amount of electricity to be used is smaller from the basic fee and the additional fee). Furthermore, when the incentive is money, the first incentive giving unit 801 gives, to the lessor 3, the amount corresponding to the fee paid by the lessee 4 (the fee acquired by subtracting larger amount as the use time is shorter from the basic fee and the additional fee).

### 5. Other Embodiments

The embodiments described above simply illustrate some modes, and any changes and modifications are possible.

The embodiments described above are configured such that the lessee 4 can receive an incentive by housing the power pack 2 rented from the lessor 3 to the station ST. In another embodiment, the incentive received by the lessee 4 may vary depending on the type of the station ST. When the lessee 4 houses the power pack 2 in the station ST managed by the dealer of the mobile body driven by the lessee 4, the incentive received by the lessee 4 may be increased compared to a case where it is housed in other stations ST.

The embodiments described above are configured such that the lessee 4 can receive the incentive by housing the power pack 2 rented from the lessor 3 in the station ST. Another embodiment may be configured such that the lessee 4 can receive the incentive even when the power pack 2 different from the power pack 2 rented from the lessor 3 is housed in the station ST. For example, in a case where two power packs 2 are to be owned by renting one from the lessor 3, even when not the power pack 2 rented from the lessor 3 but the originally carried power pack 2 is housed in the station ST, the lessee 4 can receive the incentive.

In the embodiments described above, the vehicle 5 is illustrated as the mobile body where the power pack 2 is provided. However, the mobile body is not limited to the vehicle 5 but may also be an object driven by the lessor 3 that travels on land, in the air, on the sea, or underwater. Examples of such an object may be a flying object, a ship, and the like.

In the embodiments described above, mobile terminals devices are illustrated as the lessor terminal 6 and the lessee terminal 7. However, the lessor terminal 6 and the lessee terminal 7 are not limited to the mobile terminal devices but may also be in-vehicle devices.

The processors 500, 600, 700, and 800 may be configured by a plurality of processors or may be configured by a single processor. The processors 500, 600, 700, and 800 may be hardware programmed to achieve functions of each unit to be described later. In this case, the processors 500, 600, 700, and 800 are configured with ASIC (Application Specific Integrated Circuit) or FPGA (Field Programmable Gate Array), for example.

Furthermore, each unit of each device configuring the rental system 1 illustrated in FIG. 2 to FIG. 5 is simply presented as examples, and specific implementation modes thereof are not particularly limited. That is, hardware individually corresponding to each unit is not necessarily required to be mounted and, needless to say, it is possible to employ a configuration where functions of each unit are achieved by executing a program using a single processor. Furthermore, part of the functions achieved by software in the embodiments described above may be achieved by hardware or part of the functions achieved by hardware may be achieved by software. In addition, specific detailed configurations of each of other units of each of the devices configuring the rental system 1 may be changed as desired without departing from the scope of the gist of the present invention.

Furthermore, step units of the operations shown in FIG. 6, FIG. 7, FIG. 10, FIG. 11, FIG. 12, and FIG. 13 are divided according to the main processing contents, and the present invention is not limited by the manner the processing units are divided and the names thereof. The operations may be divided into a greater number of step units according to the processing contents. Furthermore, a single step unit may be divided to include more processing. Moreover, the order of the steps may be changed as appropriate within a range not conflicting with the gist of the present invention.

### 6. Configurations Supported by the Above-Described Embodiments

The above-described embodiments support the following items.

(Item 1) A management server managing rental of a battery between a lessor renting out the battery and a lessee renting the battery, the management server including a first incentive giving unit configured to give an incentive to the lessor who has rented out the battery, in which the first incentive giving unit gives, to the lessor, the incentive corresponding to a separation distance between a position of the battery at a point when the lessee makes a request to rent the battery and a position of a fixed station where the battery is provided.

According to the management server of item 1, the incentive corresponding to the separation distance between the position of the battery at the point when the lessee makes a request to rent the battery and the position of the fixed station where the battery is provided can be given to the lessor, so that it is possible to give an appropriate incentive to the lessor. Furthermore, since the appropriate incentive can be given to the lessor, lessor's willingness to rent out can be evoked, so that the possibility of renting out and renting the battery at a position away from the fixed station can be increased. This makes it possible for the lessee to rent the battery easily.

(Item 2) The management server according to item 1, including: a request reception unit configured to receive the request from the lessee; a request cancellation unit configured to cancel the request received by the request reception unit; and an approval reception unit configured to receive, from the lessor, an approval for the request received by the request reception unit, in which the first incentive giving unit gives the incentive to the lessor who has given the approval received by the approval reception unit, the lessor having rented out the battery, and the request cancellation unit cancels the request, when the battery as a target of the request received by the request reception unit moves from the position where the request is made by the lessee by a prescribed distance or more, before the lessor gives the approval.

According to the management server of item 2, when the battery as the target of the request to rent moves by a prescribed distance or more before the lessor gives the approval, the request is cancelled. With a configuration where the incentive is set according to the separation distance, when the lessee makes a request to rent the battery while the lessor is moving the battery, the incentive to be given to the lessor may become different from the incentive that is originally supposed to be given. However, with the management server of item 2, the request to rent the battery is cancelled, so that it is possible to give a proper incentive to the lessor in an appropriate manner.

(Item 3) The management server according to item 1 or 2, including: a request reception unit configured to receive the request from the lessee; and a second incentive giving unit configured to give an incentive to the lessee, in which the request reception unit receives a first request that is the request without returning of the battery to the lessor, and the second incentive giving unit gives the incentive to the lessee, when the lessee houses the battery in the station for the first request received by the request reception unit.

According to the management server of item 2, the lessee can receive the incentive by housing the battery in the fixed station, which helps increase the willingness of the lessee to rent the battery. Therefore, the possibility of renting out and renting the battery at a position away from the fixed station can be increased further.

(Item 4) The management server according to item 3, including a permission unit configured to permit the lessor to bring out the battery provided in the station, in which the request reception unit receives a second request that is the request with returning of the battery to the lessor, and the permission unit permits the lessor to bring out the battery, when the lessee does not return the battery rented out by the lessor for a prescribed period after the lessor rents out the battery in response to the second request received by the request reception unit.

According to the management server of item 4, the battery is allowed to be brought out from the fixed station. Therefore, the lessor does not need to wait for an unnecessarily long time at the return place of the battery, which results in improving the convenience for the lessor.

(Item 5) The management server according to any one of items 1 to 4, in which the first incentive giving unit varies the incentive to be given to the lessor, according to a charge amount of the battery at a point when the lessee makes the request.

According to the management server of item 5, the incentive corresponding to the charge amount of the battery can be given to the lessor, so that it is possible to appropriately implement rental of the battery not constrained by the charge amount of the battery. This makes it possible to implement rental of the battery for a lower fee as a battery has a smaller charge amount, for example. Therefore, the convenience for the lessee can be improved, and the possibility of renting out and renting the battery at a position away from the station can be increased further.

(Item 6) The management server according to items 1 to 5, including: a request reception unit configured to receive the request from the lessee; and an approval reception unit configured to receive, from the lessor, an approval for the request received by the request reception unit, in which the request reception unit receives a third request that is the request designating a position to rent the battery, and the first incentive giving unit increases the incentive to be given to the lessor, when the approval reception unit receives the approval for the third request.

According to the management server of item 6, the lessee can designate the position to rent the battery, and a proper incentive for delivering the battery to the designated position can be given to the lessor. Therefore, the convenience for the lessor and the lessee can be improved in renting out and renting the battery.

(Item 7) The management server according to items 1 to 6, including: a request reception unit configured to receive the request from the lessee; and an approval reception unit configured to receive, from the lessor, an approval for the request received by the request reception unit, in which the request reception unit receives a fourth request that is the request designating an amount of electricity of the battery to be used and use time of the battery, and the first incentive giving unit gives, to the lessor, the incentive corresponding to the amount of electricity and the use time designated in the fourth request, when the approval reception unit receives the approval for the fourth request.

According to the management server of item 7, it is possible to implement rental of the battery by corresponding to the needs of the lessee and to give a proper incentive to the lessor by corresponding to the needs of the lessee. Therefore, the convenience for the lessor and the lessee can be improved in renting out and renting the battery.

(Item 8) A control method of a management server that manages rental of a battery between a lessor renting out the battery and a lessee renting the battery, the control method including a step of giving an incentive to the lessor who has rented out the battery, in which the step includes giving, to the lessor, the incentive corresponding to a separation distance between a position of the battery at a point when the lessee makes a request to rent the battery and a position of a fixed station where the battery is provided.

According to the control method of the management server of item 8, the same effects as those of the management server of item 1 can be achieved.

### REFERENCE SIGNS LIST

1 Rental system
2 Power pack (battery)
3 Lessor
4 Lessee
5 Vehicle
6 Lessor terminal
7 Lessee terminal
8 Management server
80 Server control device
81 Fifth communication device
800 Processor
801 First incentive giving unit
802 Second incentive giving unit
803 Upload information processing unit
804 Request processing unit (request reception unit)
805 Request cancellation unit
806 Approval/disapproval processing unit (approval reception unit)
807 Rental management unit
808 Permission unit
810 Memory
811 Control program
812 Lessor management DB
813 Lessee management DB
814 Upload information management DB
815 Request management DB
816 Approved request management DB
817 Rental management DB
818 Station management DB
819 Map data
820 Interface circuit
ST Station

What is claimed is:

1. A management server managing rental of a battery between a lessor renting out the battery and a lessee renting the battery, the management server comprising a first incentive giving unit configured to give an incentive to the lessor who has rented out the battery, wherein
the first incentive giving unit gives, to the lessor, the incentive corresponding to a separation distance between a position of the battery at a point when the lessee makes a request to rent the battery and a position of a fixed station where the battery is provided.

2. The management server according to claim 1, comprising:
a request reception unit configured to receive the request from the lessee;
a request cancellation unit configured to cancel the request received by the request reception unit; and
an approval reception unit configured to receive, from the lessor, an approval for the request received by the request reception unit, wherein
the first incentive giving unit gives the incentive to the lessor who has given the approval received by the approval reception unit, the lessor having rented out the battery, and
the request cancellation unit cancels the request, when the battery as a target of the request received by the request reception unit moves from the position where the request is made by the lessee by a prescribed distance or more, before the lessor gives the approval.

3. The management server according to claim 1, comprising:
a request reception unit configured to receive the request from the lessee; and
a second incentive giving unit configured to give an incentive to the lessee, wherein
the request reception unit receives a first request that is the request without returning of the battery to the lessor, and
the second incentive giving unit gives the incentive to the lessee, when the lessee houses the battery in the station for the first request received by the request reception unit.

4. The management server according to claim 3, comprising a permission unit configured to permit the lessor to bring out the battery provided in the station, wherein
the request reception unit receives a second request that is the request with returning of the battery to the lessor, and
the permission unit permits the lessor to bring out the battery, when the lessee does not return the battery rented out by the lessor for a prescribed period after the lessor rents out the battery in response to the second request received by the request reception unit.

5. The management server according to claim 1, wherein the first incentive giving unit varies the incentive to be given to the lessor, according to a charge amount of the battery at a point when the lessee makes the request.

6. The management server according to claim 1, comprising:
a request reception unit configured to receive the request from the lessee; and
an approval reception unit configured to receive, from the lessor, an approval for the request received by the request reception unit, wherein
the request reception unit receives a third request that is the request designating a position to rent the battery, and
the first incentive giving unit increases the incentive to be given to the lessor, when the approval reception unit receives the approval for the third request.

7. The management server according to claim 1, comprising:
a request reception unit configured to receive the request from the lessee; and
an approval reception unit configured to receive, from the lessor, an approval for the request received by the request reception unit, wherein
the request reception unit receives a fourth request that is the request designating an amount of electricity of the battery to be used and use time of the battery, and
the first incentive giving unit gives, to the lessor, the incentive corresponding to the amount of electricity and the use time designated in the fourth request, when the approval reception unit receives the approval for the fourth request.

8. A control method of a management server that manages rental of a battery between a lessor renting out the battery and a lessee renting the battery, the control method comprising
a step of giving an incentive to the lessor who has rented out the battery, wherein
the step comprises giving, to the lessor, the incentive corresponding to a separation distance between a position of the battery at a point when the lessee makes a request to rent the battery and a position of a fixed station where the battery is provided.
